(19) United States
(12) Patent Application Publication
(10) Pub. No.: US 2008/0289097 A1
(43) Pub. Date: Nov. 27, 2008

(54) Shower Apparatus

(76) Inventor: Ji Hang Jeong, Daejeon (KR)

Correspondence Address: FRANKLIN & ASSOCIATES INTERNATIONAL LLC, 230 St. Francis Drive, Suite 1, SANTA FE, NM, 87505-3538, US

(21) Appl. No.: 11/995,277

(22) PCT Filed: Jul. 7, 2006
(86) PCT No.: PCT/KR06/02658

§ 371 Date: Jan. 10, 2008

(30) Foreign Application Priority Data
Jul. 14, 2005 (KR) 10-2005-0063539

(51) Int. Cl. A47K 3/00

(52) U.S. Cl. 4/615

(57) ABSTRACT

The present invention relates to a shower apparatus having a watering plate, a water saving device and a gel filling portion in that a latching button for pushing an opening and closing ball and opening water paths is provided in such a manner that the supply of water is performed in a state that a shower head is placed horizontally or lower than a hose connection portion in height and the area of water paths formed at an inside thereof is larger than that of a waterway hole, whereby firmly opening and closing the waterway hole by means of the ball. Also, the present invention relates to a shower apparatus having a watering plate, a water saving device and a gel filling portion, in that a filter is provided so that it can easily remove external materials such as a rust and so on contained in the water of the shower head, a watering hole is slightly larger than the external material in size, so that it can previously prevent the watering hole from being blocked, a watering portion provided with a plurality of first watering holes is formed at the outside of the central portion of the watering plate, so that the water is equally jetted out the skin of the human body thereby increasing the shower efficiency, and the water is jetted out in the form of a triangle through the watering holes of a triangular shape, so that it can obtain the increasing effect of a negative ion.

### TECHNICAL FIELD

The present invention relates to a shower apparatus having a watering plate, a water saving device and a gel filling portion, and more particularly to a shower apparatus having a watering plate, a water saving device and a gel filling portion in that a latching button for pushing an opening and closing ball and opening water paths is provided in such a manner that the supply of water is performed in a state that a shower head is placed horizontally or lower than a hose connection portion in height and the area of water paths formed at an inside thereof is larger than that of a waterway hole, whereby firmly opening and closing the waterway hole by means of the ball.

Also, the present invention relates to a shower apparatus having a watering plate, a water saving device and a gel filling portion, in that a filter is provided so that it can easily remove external materials such as a rust and so on contained in the water of the shower head, a watering hole is slightly larger than the external material in size, so that it can previously prevent the watering hole from being blocked, a watering portion provided with a plurality of first watering holes is formed at the outside of the central portion of the watering plate, so that the water is equally jetted out the skin of the human body thereby increasing the shower efficiency, and the water is jetted out in the form of a triangle through the watering holes of a triangular shape, so that it can obtain the increasing effect of a negative ion.

Moreover, the present invention relates to a shower apparatus having a watering plate, a water saving device and a gel filling portion, in that a gel composed of a traditional oriental material, a spice, a vitamin (an aroma component) and so on is received in the inside of a case of the gel filling portion inserted into the shower apparatus, so that the gel is dissolved into the water supplied from the external body, whereby providing a sweet aroma and a beneficial component to the user within a certain period of time.

### BACKGROUND ART

As a side effect of a rapid growth of the industry, a shortage of fresh water sources has been realized owing to an environmental pollution, an excessive usage of the water resources and so on.

In order to overcome the phenomenon of the water shortage, a variety of policies and regulations have been established and various devices for water saving have been developed and spread.

Generally, the shower divides into a faucet and a shower apparatus. Where the water is not used during the using of the shower apparatus, the user rotates a lever to block the water. However, since it is inconvenient for the user to use the lever for blocking the water, the user uses the shower apparatus in succession without cutting off the water, so that the amount of the water used has been increased. Accordingly, a variety of devices for controlling and blocking the water have been recently proposed. However, there are defect in that the structure thereof is complicated and the cost thereof is expensive.

Among the conventional devices for water saving mounted on the shower apparatus, if the user pushes down the grip thereof, the water is supplied, on the contrary, the user unloose it, so that the water supply is stopped. However, in this water saving device, there is a problem in that the entire structure of the shower apparatus should be changed.

In order to complement the above defect, Korean patent publication No. 10-0278822 (publication date: Jan. 15, 2001) filed by the applicant of the present invention has been proposed. In the water saving apparatus for shower apparatus, it can be mounted to any shower apparatus and the supply of water is stopped in a state that the shower head is placed horizontally.

In the water saving apparatus developed by the applicant of the present invention, where the shower head is placed horizontally or lower than a hose connection portion in height, the supply of water is stopped. However, it is inconvenient to continuously use the shower apparatus on account of an inharmonious supply of water. That is, where the water is continuously supplied through the shower apparatus, there is inconveniency in that the shower head should stand upward by supporting it on another object,

Also, since the area of the water paths formed at an outer circumference is similar to or the same as that of a waterway hole, there is a problem in that it is inharmonious to open and close the waterway hole by means of a ball.

In the meantime, recently, a shower head named as a water saving type shower is well known, which is disclosed in Japanese patent laying-open gazette No. hei 8-266940. That is, in the shower head of the water saving type, a diameter reduction portion is formed at the inside of the shower head, while the diameter of the outlet thereof is enlarged, thereby saving the water. However, since it needs separated parts so as to form the diameter reduction portion, there is a defect in that the manufacturing cost is increased.

Especially, in order to reduce the amount of the water used, it is necessary to reduce the total area of the watering holes. In this case, it is necessary to reduce the number of the watering holes or lessen the diameter of the watering hole. However, where the number of the watering holes is reduced, the dispersion effect of the water is lowered.

For this reason, when the user takes a shower, it is difficulty for him to take a shower properly. Also, since the amount of the water contacted with the user's body is comparatively reduced, there is a defect in that the washing effect is lowered. Moreover, the shower time becomes longer, thereby it cannot obtain the aim of water saving.

Also, when each watering hole simply becomes smaller, it can show the effect of water saving. However, since the spraying pressure becomes higher, there is a defect in that the user feels a pain during contacting the water with his body.

In the meantime, a positive ion and a negative ion exist in the atmosphere in balance. Here, it is well known that the negative ion has a good effect on the operation efficiency, the cheerfulness, the fatigue, the recovering and so on. Especially, the negative ion is largely generated from the peripheral of the waterfall. That is, the negative ion is generated when the dropping water is pulverized.

As above, the phenomenon of increasing the negative ion in the peripheral air is named as a lenard effect. The lenard effect can be equally applied to the water for shower apparatus. That is, the negative ion can be generated during the use of the conventional head.

In the meantime, a shower head having a watering plate for increasing the amount of the negative ion and obtaining the effect of water saving is disclosed in Korean patent publication No. 2004-0088460.

However, in the conventional shower head having the watering plate, as described above, the watering hole simply becomes smaller, so that it can show the effect of water saving. However, since the spraying pressure becomes higher, there is a defect in that the user feels a pain during contacting the water with his body.

Also, in the conventional shower head having the watering plate, since the watering holes of the watering plate are intensively arranged on the central portion thereof in the shape of a ring, there are problems in that the water of the shower apparatus is concentrated on the center of the user's body and the user frequently moves right and left or the user frequently moves the shower head right and left on account of the partial injection of the water. Also, because the watering hole of the watering plate is formed by means of an etching process during the manufacturing thereof, there is a problem in that it can easily close the watering hole owing to the a rust of the pipe and so on.

### DISCLOSURE OF INVENTION

### Technical Problem

Accordingly, the present invention has been made to solve the above-mentioned problems occurring in the prior art, and an object of the present invention is to provide a shower apparatus in that a latching button for pushing an opening and closing ball and opening water paths is provided, so that the supply of water can be performed in a state that a shower head is placed horizontally or lower than a hose connection portion in height.

Another object of the present invention is to provide a shower apparatus in that the area of water paths formed at an inside thereof is larger than that of a waterway hole, whereby firmly opening and closing the waterway hole by means of the ball.

Further another object of the present invention is to provide a shower apparatus in that a filter is provided so that it can easily remove external materials such as a rust and so on contained in the water of the shower head, a watering hole is slightly larger than the external material in size, so that it can previously prevent the watering hole from being blocked, a watering portion provided with a plurality of first watering holes is formed at the outside of the central portion of the watering plate, so that the water is equally jetted out the skin of the human body whereby increasing the shower efficiency, and the water is jetted out in the form of a triangle through the watering holes of a triangular shape, so that it can obtain the increasing effect of a negative ion.

Further another object of the present invention is to provide a shower apparatus in that a gel composed of a traditional oriental material, a spice, a vitamin (an aroma component) and so on is received in the inside of a case of the gel filling portion inserted into the shower apparatus, so that the gel is dissolved into the water supplied from the external body, whereby providing a sweet aroma and a beneficial component to the user within a certain period of time.

### Technical Solution

To accomplish the objects, the present invention provides a shower apparatus having a body for receiving a water from outside and a shower head body provided with a watering plate for discharging the water to outside communicated with the body, the shower head body comprising: a connector having a thread portion formed at an inner circumference thereof and a stepped portion formed at a lower portion thereof; the watering plate having a watering portion provided with a plurality of first watering holes of a polygonal shape formed at a part of the central portion and a periphery thereof and a plurality of second watering holes having the same size as the first watering hole formed at the outside of the watering portion; and a filter of a minute mesh shape formed at a back of the watering plate by means of a rubber ring interposed between them in order to prevent the watering holes to be blocked owing to an external material.

Preferably, the shower apparatus further comprises a water saving apparatus for saving the supplied water formed at a lower portion thereof, the water saving apparatus comprising: the body of a cylindrical shape having a waterway hole penetrated through a center of a wall formed at a middle of an interior thereof, a pressurization unit insertion hole penetrated through a side wall of one side of the waterway hole, and a button latching step of a predetermined height formed on an outer periphery of the pressurization unit insertion hole; a ball case of a cylindrical shape blocked at one end portion thereof, the ball case comprising a plurality of water paths formed at an outer circumference and a pressurization unit insertion groove corresponding to the pressurization unit insertion hole of the body; a ball for opening and closing the waterway hole capable of moving along an inside of the ball case; a ball pressurization unit inserted into the pressurization unit insertion hole and having a pressurization slanting collar for pushing the ball out of the waterway hole to open it; a main button for pressing the ball pressurization unit elastically supported to an inside of the button latching step of the body; and a connecting means formed at an end portion of the body, in which the ball case is inserted.

Preferably, an area ratio of the waterway hole of the body to the water path formed at an outer circumference of the ball case lengthwise is 1:1 through 1:10, a diameter of the ball case at an opening end portion of the ball is larger than that of the ball case at a closing end portion of the ball about 1 mm through 3 mm, and a diameter of the ball is smaller than an inner diameter of the ball case about 0.1 mm through 1 mm.

Preferably, a latching button having guide steps is inserted into a guide groove of the main button and movable in the direction of a side thereof and the latching step formed at the latching button is inserted into a latching hole formed at one side of the button latching step formed at the body.

Preferably, a groove is formed at an outer peripheral of the waterway hole of the body located at an inserting side of the ball case and a leakage preventing plate having a superior contractibility such as a rubber is further mounted to the groove.

Preferably, a retainer is further formed at the pressurization unit insertion hole of the body in order to prevent a water leakage between the ball pressurization unit of a pillar shape and the pressurization unit insertion hole.

Preferably, a gel filling portion is formed at one side of the shower apparatus in order to provide a sweet aroma and a beneficial component to a user by dissolving the gel into the water supplied from the external body and comprises a receiving space formed at an inside thereof, a case formed at one side of the body, a circulating hole passing through a portion of the case contacted with the water flowing into an inside of the body, and a filter member formed at the inside of the case.

Preferably, the case is divided into the solution room and the contents receiving room by means of the filter member, the solution room is located at an inside of a circulating hole, and a water-soluble gel composed of a traditional oriental material, a spice, a vitamin (an aroma component) is filled into the contents receiving room.

Preferably, the filter member comprises a filter membrane and a supporting frame for fixing the filter membrane.

Preferably, the circulating hole becomes gradually narrow toward the inside thereof in size.

Preferably, the case comprises a bended water guiding slope way at one side surface contacted with the circulating hole.

### ADVANTAGEOUS EFFECTS

As can be seen from the foregoing, in the water saving apparatus for the shower apparatus, there are effects in that the latching button for pushing the opening and closing ball and opening the water paths is operated, whereby the supply of water can be performed in a state that the shower head is placed horizontally or lower than the hose connection portion in height and the area of water paths of the ball case is larger than that of the waterway hole, whereby firmly opening and closing the waterway hole by means of the ball.

Also, in the showering plate of the shower head, there are other effects in that the filter is provided so that it can easily remove external materials such as a rust and so on contained in the water of the shower head, whereby previously preventing the watering hole from being blocked, the watering portion provided with the plurality of first watering holes is formed at the outside of the central portion of the watering plate, so that the water is equally jetted out the skin of the human body thereby increasing the shower efficiency, and the water is jetted out in the form of a triangle through the watering holes of a triangular shape, so that it can obtain the increasing effect of a negative ion.

Moreover, in the gel filling portion, there are further other effects in that a gel composed of a traditional oriental material, a spice, a vitamin (an aroma component) and so on is received in the inside of a case of the gel filling portion inserted into the shower apparatus, so that the gel is dissolved into the water supplied from the external body, whereby providing a sweet aroma and a beneficial component to the user within a certain period of time.

### BRIEF DESCRIPTION OF THE DRAWINGS

The above as well as the other objects, features and advantages of the present invention will be more apparent from the following detailed description taken in conjunction with the accompanying drawings, in which:

FIG. 1 is a schematic exploded view illustrating a water saving apparatus according to a first embodiment of the present invention;

FIG. 2 is a perspective view illustrating the water saving apparatus according to the first embodiment of the present invention;

FIG. 3 is a exploded view illustrating a path opening button according to the first embodiment of the present invention;

FIG. 4 is a sectional view illustrating a closing status of the water saving apparatus according to the first embodiment of the present invention;

FIG. 5 is a sectional view illustrating an opening status of the water saving apparatus according to the first embodiment of the present invention;

FIG. 6 is a sectional view illustrating a ball case and a ball of the water saving apparatus according to the first embodiment of the present invention;

FIG. 7 is a perspective view illustrating a shower apparatus provided with the water saving apparatus according to the first embodiment of the present invention;

FIG. 8 is a schematic exploded view illustrating a shower head having a watering plate according to a second embodiment of the present invention;

FIG. 9 is a perspective view illustrating a shower head having a filter according to the second embodiment of the present invention;

FIG. 10 is an enlarged perspective view illustrating the watering plate according to the second embodiment of the present invention;

FIG. 11 is a perspective view illustrating a gel filling portion according to a third embodiment of the present invention;

FIG. 12 is a sectional view illustrating a case according to the third embodiment of the present invention;

FIG. 13 is a perspective view illustrating a supporting frame according to the third embodiment of the present invention;

FIG. 14 is a perspective view illustrating a filter member according to the third embodiment of the present invention;

FIG. 15 is a sectional view illustrating a filter member according to the third embodiment of the present invention;

FIG. 16 is a sectional view illustrating a gel filling portion according to the third embodiment of the present invention;

FIG. 17 is an enlarged sectional view of a portion “A” of FIG. 16; and

FIG. 18 illustrates a shower apparatus having the gel filling portion according to the third embodiment of the present invention.

### BEST MODE FOR CARRYING OUT THE INVENTION

A preferred embodiment of the invention will be described in detail below with reference to the accompanying drawings.

### Example 1

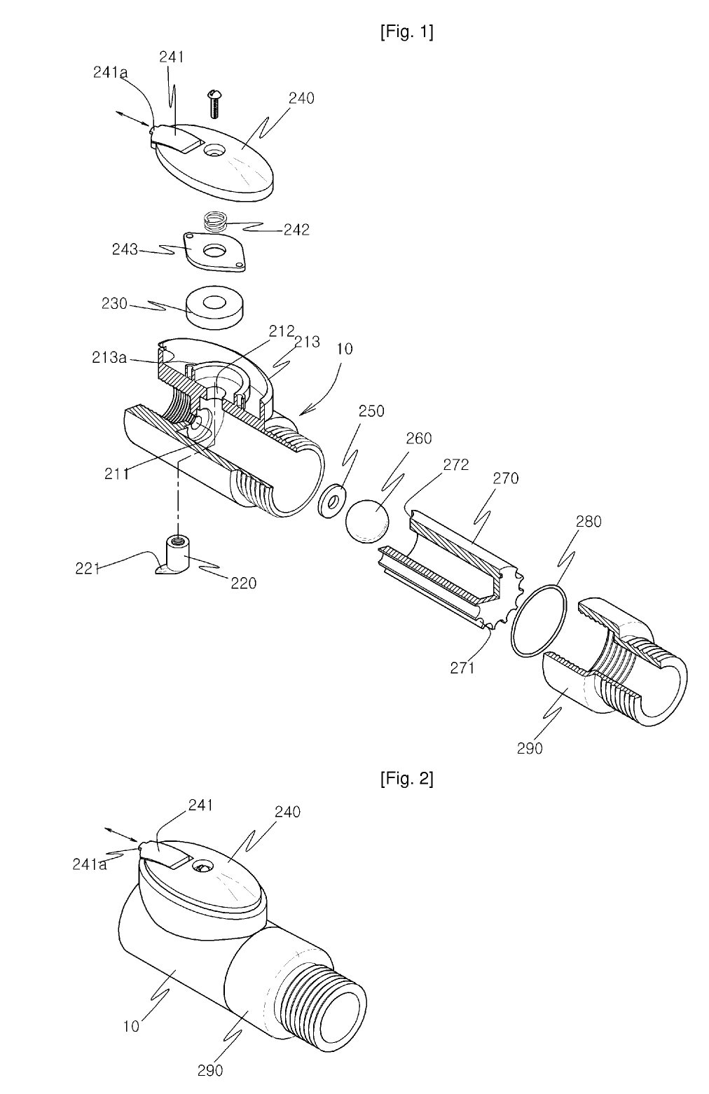

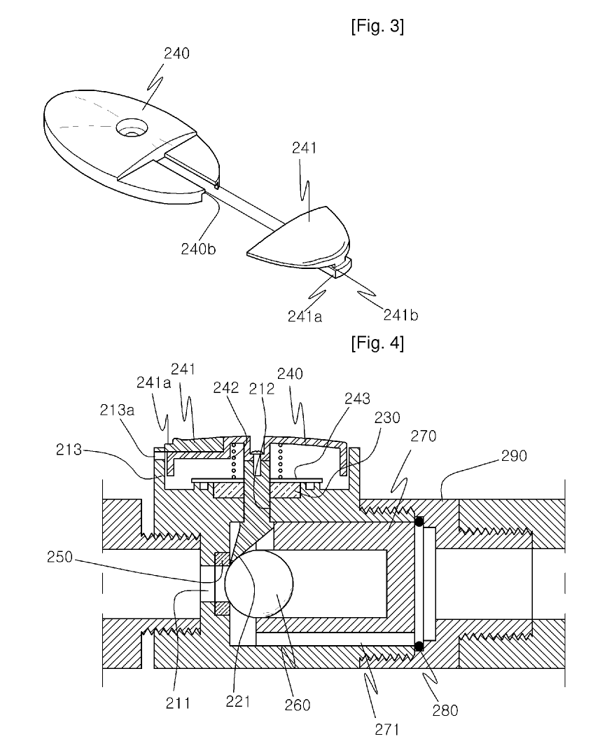

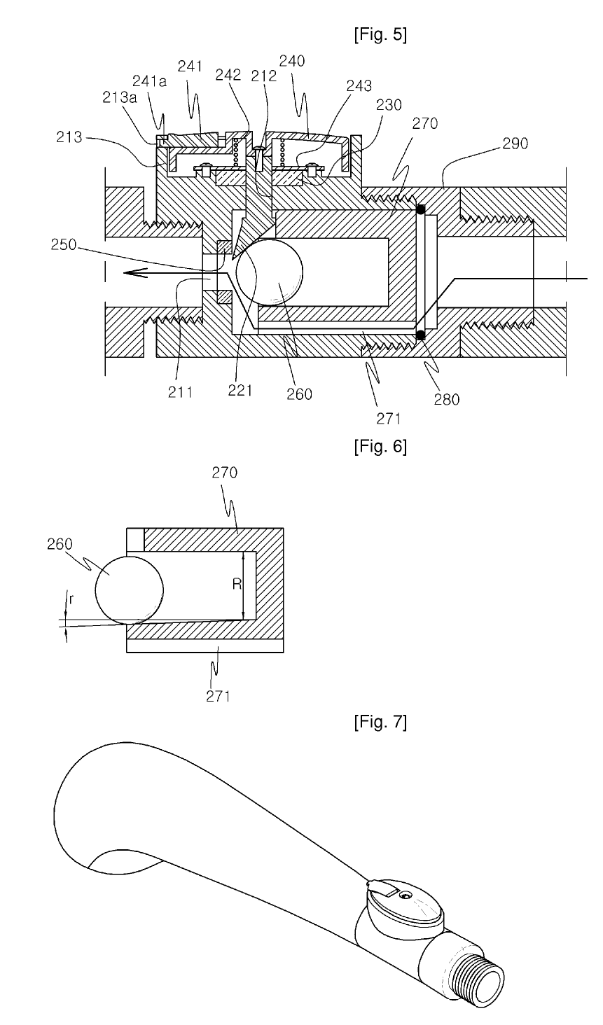

FIG. 1 is a schematic exploded view illustrating a water saving apparatus according to a first embodiment of the present invention, FIG. 2 is a perspective view illustrating the water saving apparatus according to the first embodiment of the present invention, FIG. 3 is a exploded view illustrating a path opening button according to the first embodiment of the present invention, FIG. 4 is a sectional view illustrating a closing status of the water saving apparatus according to the first embodiment of the present invention, FIG. 5 is a sectional view illustrating an opening status of the water saving apparatus according to the first embodiment of the present invention, FIG. 6 is a sectional view illustrating a ball case and a ball of the water saving apparatus according to the first embodiment of the present invention, and FIG. 7 is a perspective view illustrating a shower apparatus provided with the water saving apparatus according to the first embodiment of the present invention.

As shown in the drawings, the water saving apparatus for a shower apparatus according to the present invention includes a body 10 of a cylinder shape, a ball case 270 mounted in the body 10, a ball 260 and a button 240 and so on.

As shown in FIG. 1, the body 10 includes a button latching step 213 of an oval shape formed at the outside of one side of the cylindrical body 10 and a waterway hole 211 penetrated through a center of a wall formed at the middle of the interior thereof.

Also, a pressurization unit insertion hole 212 for inserting the following a ball pressurization unit 220 penetrated therethrough formed at the center of a surface, at which the button latching step 213 is formed. Moreover, a latching hole 213a is penetrated through one side of the button latching step 213.

Screw threads formed at the both inner surfaces of the body 10 may be screw-coupled to the following connection means and the shower body.

A groove is formed at the outer peripheral of the waterway hole 211 of the body 10 located at the inserting side of the ball case 270. A leakage preventing plate 250 having a superior contractibility such as a rubber is further mounted to the groove in order to firmly close the waterway hole 211 through the ball 260.

Also, the ball case 270 is formed at the inside of the body 10.

As shown in FIG. 1, the ball case 270 of a cylindrical shape is blocked at one end portion thereof. The ball case 270 includes a plurality of water paths 271 formed at an outer circumference and a pressurization unit insertion groove 272 corresponding to the pressurization unit insertion hole 212 of the body 10.

The pressurization unit insertion groove 272 may provide the movable space of the ball pressurization unit 220.

Also, a display protrusion for displaying the inserting direction of the ball case 270 is further formed on the blocked portion of the ball case 270, that is, the opposite side of the pressurization unit insertion groove 272.

The opening and closing ball 260 is formed at the inside of the ball case 270.

The ball 260 for opening and closing the waterway hole 211 serves to close the waterway hole 211 by moving it toward the waterway hole 211, where the body 10 is placed horizontally or the waterway hole is low in height.

The ball pressurization unit 220 formed at the pressurization unit insertion hole 212 of the body 10 serves to open the waterway hole 211 by pushing the ball 260.

The groove is formed at the outer peripheral of the waterway hole 211 of the body 10 facing the ball 260 and the leakage preventing plate 250 is further mounted to the groove in order to increase the effect of the opening and closing of the water paths.

The leakage preventing plate 250 is made of a rubber and so forth having a superior elasticity.

The ball pressurization unit 220 of a pillar shape having the same inside diameter as the pressurization unit insertion hole 212 includes a pressurization slanting collar 221 at an end portion of one side thereof. That is, the ball pressurization unit 220 includes an end portion formed at the pressurization slanting collar 221 facing the waterway hole 211 formed at the inside of the body 10 and an opposite end portion penetrated into the body, protruded toward the inside space of the button latching step 213, and fixed to a main button 240.

As shown in FIG. 1, FIG. 4 and FIG. 5, the main button 240 is mounted in the inside space of the button latching step 213 and fixed to the upper end of the ball pressurization unit 220.

The ball pressurization unit 220 is pressed into the inside of the body 10 according to the press of the main button 240, so that the pressurization slanting collar 221 formed at an end portion of the inside of the ball pressurization unit 220 pushes the ball 260 out of the waterway hole 211 to open it, thereby the water is supplied.

As shown in FIG. 3, the main button 240 includes a stepped portion formed at one side thereof having guide steps 240a at both edges of the stepped portion and a latching button 241 movable to the stepped portion.

The latching button 241 serves to maintain the opening status of the waterway hole 211 by allowing the ball pressurization unit 220 to press the ball 260. As shown in FIG. 3, the latching button 241 includes guide grooves 241b for guiding the guide steps 240a therein and a latching step 241a formed at one side thereof.

As shown in FIG. 5, the latching step 241a formed at the latching button 241 is inserted into the latching hole 213a formed at one side of the button latching step 213.

In the operation of the latching button 241, firstly, the ball pressurization unit 220 is pressed into the inside of the body 10 according to the press of the main button 240, so that the ball pressurization unit 220 presses down the ball 260 and the ball 260 is separated from the waterway hole 211. At this time, the latching button 241 is pushed in the direction of the latching hole 213a, so that the latching step 241a formed at the latching button 241 is inserted into the latching hole 213a. Accordingly, the pressurized main button 240 is fixed to the button latching step 213, so that it can maintain the separated status between the ball 260 and the waterway hole 211 and the opening status of the waterway hole 211.

A connecting means 290 is formed at an end portion of the body 10, in which the ball case 270 is inserted, and a head of the shower is connected to another end of the body 10.

The shower is connected to a hose of the shower (not shown).

Preferably, the area ratio of the waterway hole 211 of the body 10 to the water path 271 formed at the outer circumference of the ball case 270 lengthwise is 1:1 through 1:10.

That is, since the area of the waterway hole 211 becomes larger than that of the water path 271, it can sufficiently press on the water moved to the waterway hole 211 through the water path 271. Accordingly, in case that the ball 260 is adhered close to the waterway hole 211, as though a small shaking is generated, the ball 260 can allow the waterway hole 211 to be made airtight through the water pressure.

However, where the area of the waterway hole 211 is extremely widened, since the steps between the water paths 271 become excessively narrow, the ball case 270 is in bad shape. Also, because the water pressure applied to the ball 260 is extremely high, as though the shower apparatus is erected vertically, the ball 260 is not separated from the waterway hole 211 and the waterway hole 211 is made airtight. Accordingly, it is desirable to have the range of the above mentioned area ratio.

In the water saving apparatus for the shower apparatus as described above, as shown in FIG. 6, the diameter of the ball case 270 at the opening end portion of the ball 260 is larger than that of the ball case 270 at the closing end portion of the ball 260 about 1 mm through 3 mm, so that it has a slope r gradually lowered toward the opening end portion. Here, it is preferred that the slope r is about 1° through 3°. Accordingly, as though the water saving apparatus is placed horizontally, the ball 260 rolls toward the waterway hole 211 to block it.

Also, the diameter of the ball 260 is smaller than the inner diameter of the ball case 270 about 0.1 mm through 1 mm. Accordingly, when the ball 260 is inserted in the inside of the ball case 270, there is not gap between the ball 260 and the inside of the ball case 270.

If the gap between the ball 260 and the inside of the ball case 270 is large, since the water flowing through the water path 271 is flowed into the inside of the ball case 270, the inflowing water pushes the ball 260 toward the waterway hole 211 to close it and stop the supply of water, irrelevantly to the intention of the user. Accordingly, it is preferred that the gap between the ball 260 and the inside of the ball case 270 is minimized.

### Example 2

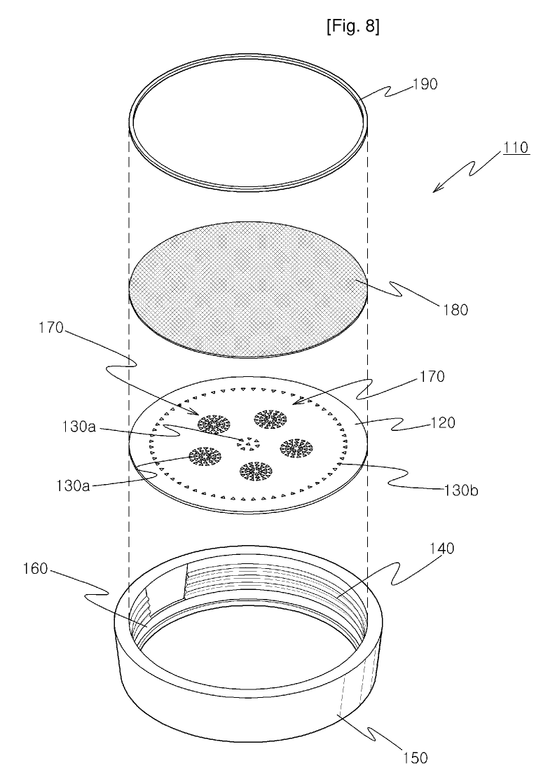

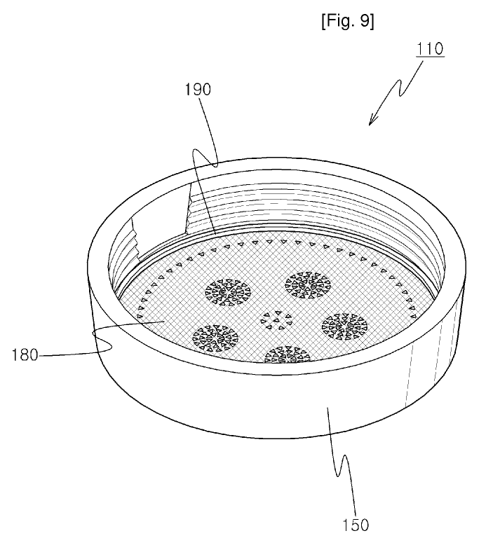

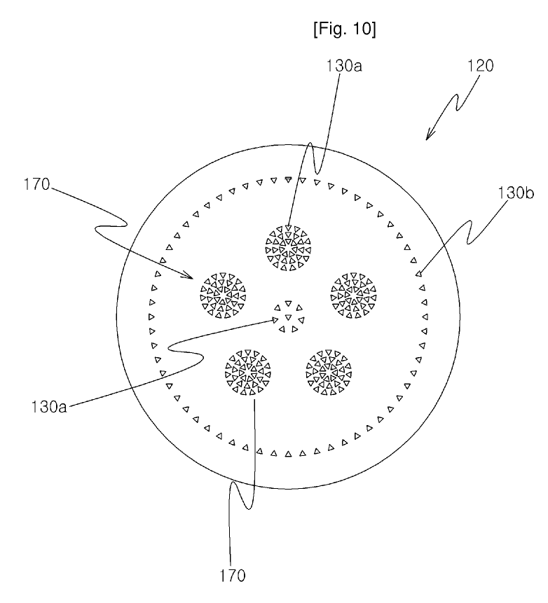

FIG. 8 is a schematic exploded view illustrating a shower head having a watering plate according to a second embodiment of the present invention, FIG. 9 is a perspective view illustrating a shower head having a filter according to the second embodiment of the present invention, and FIG. 10 is an enlarged perspective view illustrating the watering plate according to the second embodiment of the present invention. Here, the watering plate 120 having a plurality of watering hole 130a and 130b is fixed to the lower side of the shower head body 110.

The shower head body 110 includes a connector 150 having a thread portion 140 formed at an inner circumference thereof and a stepped portion 160 formed at the lower portion thereof, and the watering plate 120 having a watering portion 170 provided with a plurality of first watering holes 130a of a triangular shape formed at a part of the central portion and a periphery thereof and a plurality of second watering holes 130b having the same size as the first watering hole 130a formed at the outside of the watering portion 170.

Also, the shower head body 110 further includes the filter 180 of a minute mesh shape formed at the back of the watering plate 120 by means of a rubber ring 190 interposed between them in order to prevent the watering holes to be blocked owing to the external material.

The operation and effect of the shower head having the above-mentioned structure according to the second embodiment of the present invention will be described in detail below.

As shown in FIG. 8 through FIG. 10, since the watering plate 120 having the plurality of watering holes 130a and 130b is fixed to the lower side of the shower head body 110, the water supplied through the shower hose passes through the inside of the shower head body 110 and branches off by means of the plurality of watering hole 130a and 130b to be discharged into outside.

Here, as shown in FIG. 8 and FIG. 9, the stepped portion 160 is formed at the lower portion of the connector 150 having the thread portion 140 formed at an inner circumference thereof and then, the watering plate 120 is fixed to the stepped portion 160.

The watering plate 120 includes the plurality of first watering holes 130a of a triangular shape formed at the part of the central portion thereof and the watering portion 170 having the plurality of first watering holes 130a of a triangular shape separated from each other at the periphery thereof. Also, the plurality of second watering holes 130b having the same size as the first watering holes 130a is formed at the periphery of the outside of the watering portion 170, so that the discharged water branching off by means of the plurality of watering holes 130a and 130b is intensively jetted out the periphery of the central portion, not the very central portion of the user. Also, the discharged water is effectively jetted out the arm and the waist of the user through the plurality of second watering holes 130b, so that the water is equally jetted out the skin of the human body, thereby increasing the shower efficiency.

Especially, since the shape of the watering holes 130a and 130b is a triangle not a circle, the friction of the water branching off by means of the plurality of watering holes 130a and 130b of the watering plate 120 is larger than that using the circular watering hole. Also, where the water is jetted out in the form of a triangle, the waterdrop thereof maintains the triangular state owing to the cohesion during the falling thereof and a negative ion is brought into from the air, thereby obtain the increasing effect of the negative ion.

Also, the shape of the watering hole may be a polygon such as a square, a pentagon, a hexagon and so on.

In the meantime, since the size of the external is maximally 0.2 mm through 0.3 mm, it is preferred that the length of a side of the polygon is about 0.4 mm through 1.2 mm in order to prevent the watering hole to be blocked on account of the external material.

Also, the filter 180 of a minute mesh shape for preventing the closing of the watering hole is fixed to the back of the watering plate 120 by means of a rubber ring 190 interposed between them. Accordingly, where the rust generated from a water pipe is flowed into the shower head body together with the shower water, it strains the rust though the filter 180 to be jetted out, so that it can prevent the watering holes 130a and 130b of the watering plate 120 to be blocked owing to the external material. Moreover, since the filter 180 is easily separated from the screw type connector 150, the filter 180 can be easily cleaned.

The filter 180 for preventing the closing of the watering holes 130a and 130b fixed to the back of the watering plate 120 may be a nonwoven fabric in order to improve the filtering function.

### Example 3

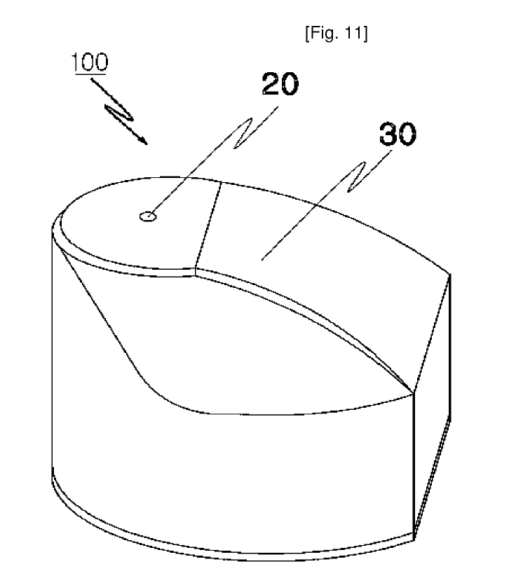

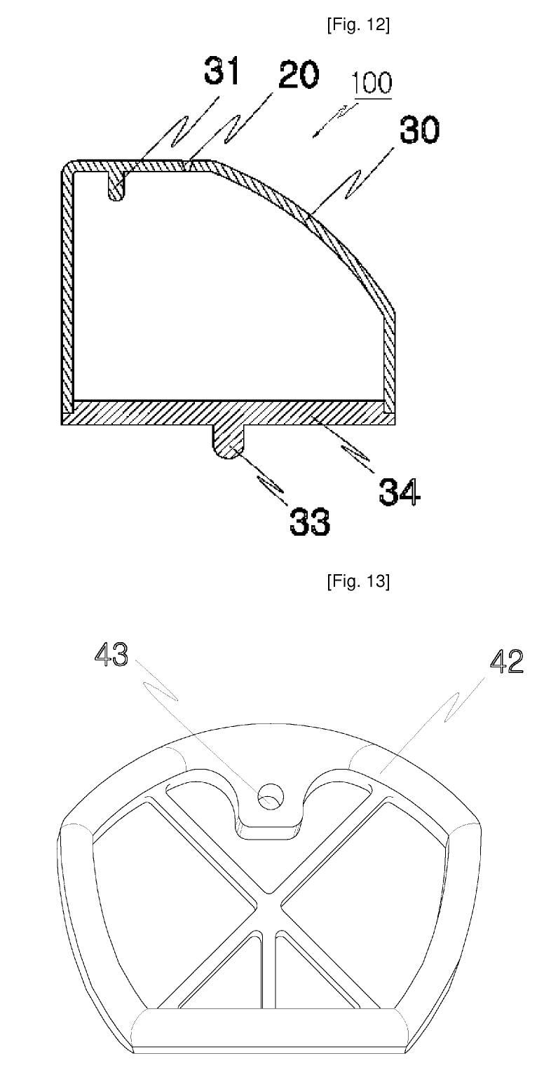

FIG. 11 is a perspective view illustrating a gel filling portion according to a third embodiment of the present invention and FIG. 12 is a sectional view illustrating a case according to the third embodiment of the present invention.

As shown in FIG. 11 and FIG. 12, the gel filling portion 10 according to the present invention includes a case 30 formed at one side of the body 10, a circulating hole 20 passing through a portion of the case 30 contacted with the water flowing into the inside of the body 10, and a filter member formed at the inside of the case 30.

That is, the filter member is mounted at the inside of the case 30 having the circulating hole 20.

As shown in FIG. 16, the case 30 according to the present invention includes an opening portion for receiving the contents and a case cover 34 for closing the opening portion. Also, the case 30 is divided into two parts, that is, a solution room 50 and contents receiving room 60 by means of the filter member having a semipermeable filter, which is formed at one side of the inside of the case 30.

The case cover 34 is coupled to the opening portion of the case 30 in order to close it. Also, the case cover 34 includes a fixing protrusion 33 coupled to the body 10 at one side thereof.

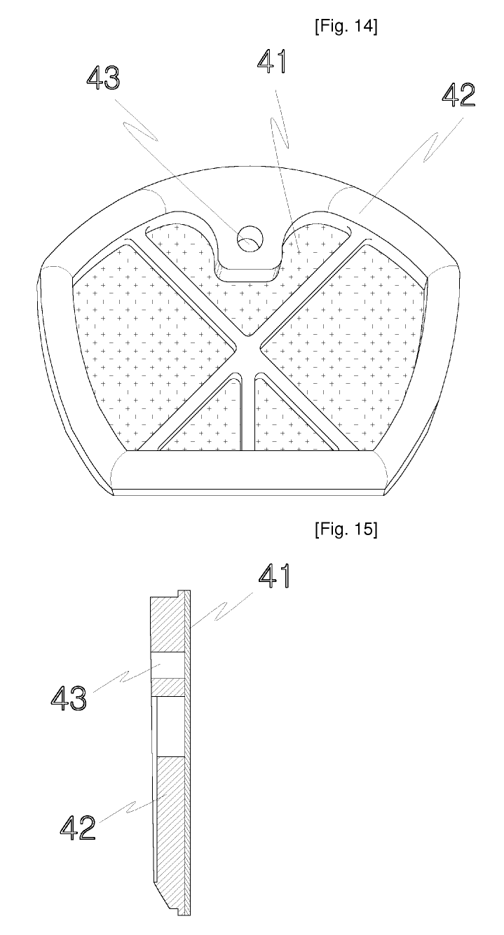

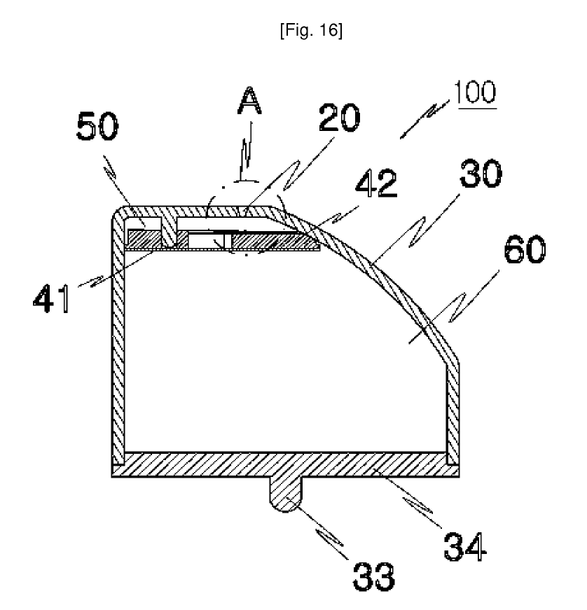

FIG. 13 is a perspective view illustrating a supporting frame according to the third embodiment of the present invention, FIG. 14 is a perspective view illustrating a filter member according to the third embodiment of the present invention, FIG. 15 is a sectional view illustrating a filter member according to the third embodiment of the present invention, and FIG. 16 is a sectional view illustrating a gel filling portion according to the third embodiment of the present invention.

As shown in the drawings, the filter member includes a filter membrane 41 and a supporting frame 42 for fixing the filter membrane 41.

As described above, the case 30 is divided into the solution room 50 and the contents receiving room 60 by means of the filter member. That is, the solution room 50 is located at the inside of the circulating hole 20. Also, a water-soluble gel composed of a traditional oriental material, a spice, a vitamin (an aroma component) and so on is filled into the contents receiving room 60.

Also, the supporting frame 42 is extruded and a combination groove 43 coupled to a combination protrusion 31 of the case 30 is formed at one side of the supporting frame 42. It is preferred that the filter membrane 41 is a nonwoven fabric or a mesh type member.

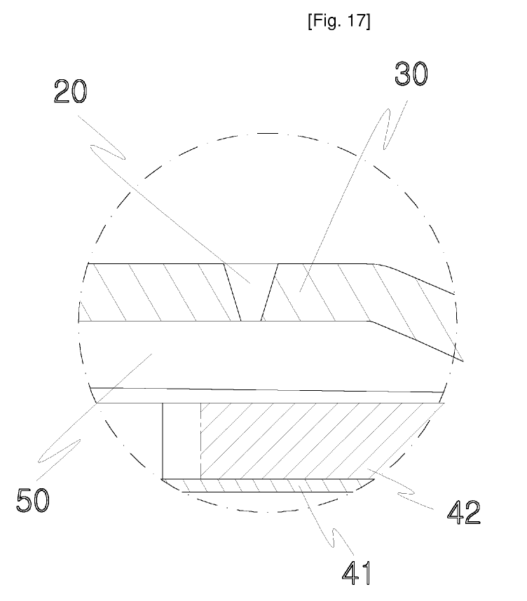

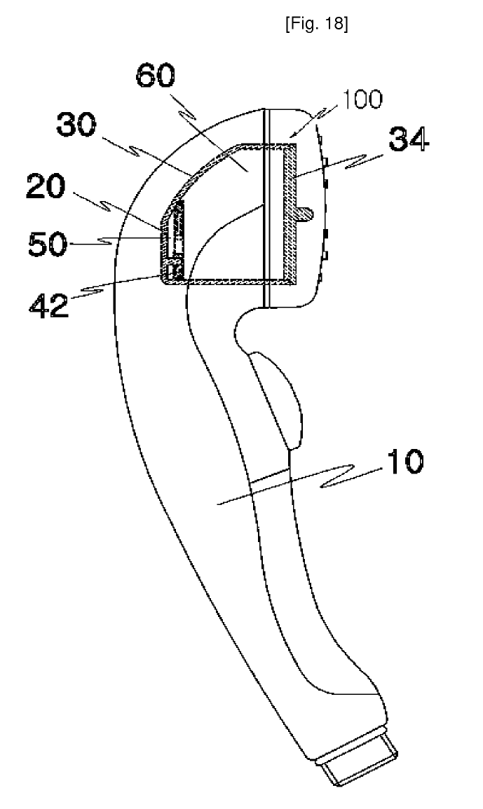

FIG. 17 is an enlarged sectional view of a portion “A” of FIG. 16 and FIG. 18 illustrates a shower apparatus having the gel filling portion according to the third embodiment of the present invention.

As shown in the drawings, the circulating hole 20 passes through one side portion of the case 30 contacted with the water flowing into the inside of the body 10. Here, the size of the circulating hole 20 becomes gradually narrow toward the inside thereof.

Accordingly, the water supplied from the body 10 flows along the outer circumference of the upper portion of the case 30 and then, flows into the solution room 50 through the circulating hole 20 of the case 30 by means of a Bernoulli's theorem. Here, a turbulent flow and a swirl flow are generated in the solution room 50. The water flowing into the solution room 50 passes through the filter membrane 41 and flows into the contents receiving room 60 to dissolve the water-soluble gel composed of the traditional oriental material, the spice and the vitamin (an aroma component). Therefore, the dissolved solution flows out the solution room 50 through the filter membrane 41 again and is uniformly mixed by means of the turbulent and swirl flow reaction and then, is discharged through a water outlet 80.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

### INDUSTRIAL APPLICABILITY

The present invention relates to a shower apparatus having a watering plate, a water saving device and a gel filling portion in that a latching button for pushing an opening and closing ball and opening water paths is provided in such a manner that the supply of water is performed in a state that a shower head is placed horizontally or lower than a hose connection portion in height and the area of water paths formed at an inside thereof is larger than that of a waterway hole, whereby firmly opening and closing the waterway hole by means of the ball.

1. A shower apparatus having a body for receiving a water from outside and a shower head body provided with a watering plate for discharging the water to outside communicated with the body, the shower head body comprising: a connector having a thread portion formed at an inner circumference thereof and a stepped portion formed at a lower portion thereof; the watering plate having a watering portion provided with a plurality of first watering holes of a polygonal shape formed at a part of the central portion and a periphery thereof and a plurality of second watering holes having the same size as the first watering hole formed at the outside of the watering portion; and a filter of a minute mesh shape formed at a back of the watering plate by means of a rubber ring interposed between them in order to prevent the watering holes to be blocked owing to an external material.

2. A shower apparatus as claimed in claim 1 further comprising a water saving apparatus for saving the supplied water formed at a lower portion thereof, the water saving apparatus comprising: the body of a cylindrical shape having a waterway hole penetrated through a center of a wall formed at a middle of an interior thereof, a pressurization unit insertion hole penetrated through a side wall of one side of the waterway hole, and a button latching step of a predetermined height formed on an outer periphery of the pressurization unit insertion hole; a ball case of a cylindrical shape blocked at one end portion thereof, the ball case comprising a plurality of water paths formed at an outer circumference and a pressurization unit insertion groove corresponding to the pressurization unit insertion hole of the body, a ball for opening and closing the waterway hole capable of moving along an inside of the ball case; a ball pressurization unit inserted into the pressurization unit insertion hole and having a pressurization slanting collar for pushing the ball out of the waterway hole to open it; a main button for pressing the ball pressurization unit elastically supported to an inside of the button latching step of the body; and a connecting means formed at an end portion of the body, in which the ball case is inserted.

3. A shower apparatus as claimed in claim 2, wherein an area ratio of the waterway hole of the body to the water path formed at an outer circumference of the ball case lengthwise is 1:1 through 1:10, a diameter of the ball case at an opening end portion of the ball is larger than that of the ball case at a closing end portion of the ball about 1 mm through 3 mm, and a diameter of the ball is smaller than an inner diameter of the ball case about 0.1 mm through 1 mm.

4. A shower apparatus as claimed in claim 2, wherein a latching button having guide steps is inserted into a guide groove of the main button and movable in the direction of a side thereof and the latching step formed at the latching button is inserted into a latching hole formed at one side of the button latching step formed at the body.

5. A shower apparatus as claimed in claim 2, wherein a groove is formed at an outer peripheral of the waterway hole of the body located at an inserting side of the ball case and a leakage preventing plate having a superior contractibility such as a rubber is further mounted to the groove.

6. A shower apparatus as claimed in claim 2, wherein a retainer is further formed at the pressurization unit insertion hole of the body in order to prevent a water leakage between the ball pressurization unit of a pillar shape and the pressurization unit insertion hole.

7. A shower apparatus as claimed in claim 1, wherein a gel falling portion is formed at one side of the shower apparatus in order to provide a sweet aroma and a beneficial component to a user by dissolving the gel into the water supplied from the external body and comprises a receiving space formed at an inside thereof, a case formed at on side of the body, a circulating hole passing through a portion of the case contacted with the water flowing into an inside of the body, and a filter member formed at the inside of the case.

8. A shower apparatus as claimed an claim 7, wherein the case is divided into the solution room and the contents receiving room by means of the filter member, the solution room is located at an inside of a circulating hole, and a water-soluble gel composed of a traditional oriental material, a spice, a vitamin (an aroma, component) is failed into the contents receiving room.

9. A shower apparatus as claimed in claim 7, wherein the filter member comprises a filter membrane and a supporting frame for fixing the filter membrane.

10. A shower apparatus as claimed in claim 7, wherein the circulating hole becomes gradually narrow toward the inside thereof in size.

11. A shower apparatus as claimed in claim 7, wherein the case comprises a bended water guiding slope way at one side surface contacted with the circulating hole.
